(19) United States
(12) Patent Application Publication
(10) Pub. No.: US 2024/0107633 A1
(43) Pub. Date: Mar. 28, 2024

(54) HEATER ELEMENT, HEATER UNIT, AND HEATER SYSTEM FOR HEATING VEHICLE INTERIOR

(71) Applicant: NGK INSULATORS, LTD., Nagoya-City (JP)

(72) Inventors: Yukio MIYAIRI, Nagoya-Shi (JP); Masaaki MASUDA, Nagoya-Shi (JP); Takuya NAKASHIMA, Nagoya-Shi (JP); Hirofumi YAMAGUCHI, Nagoya-Shi (JP); Toru HAYASE, Nagoya-Shi (JP); Koji KUZUTANI, Konan-Shi (JP)

(73) Assignee: NGK INSULATORS, LTD., Nagoya-City (JP)

(21) Appl. No.: 18/527,771

(22) Filed: Dec. 4, 2023

Related U.S. Application Data
(63) Continuation of application No. PCT/JP2022/013315, filed on Mar. 22, 2022.

(30) Foreign Application Priority Data
Jun. 24, 2021 (JP) 2021-104974

(51) Int. Cl. H05B 3/03; H05B 3/26

(52) U.S. Cl. CPC H05B 3/03; H05B 3/26; H05B 2203/02; H05B 2203/023; H05B 2203/024

(57) ABSTRACT

A heater element includes: a honeycomb structure including an outer peripheral wall and partition walls disposed on an inner side of the outer peripheral wall, the partition walls defining a plurality of cells, each of the cells extending from a first end face to a second end face to form a flow path; a pair of electrode layers provided on the outer peripheral wall and the partition walls on the first end face and the second end face; and terminals capable of electrically connecting the electrode layers to a conducting wire. At least a part of each of the electrode layers has an extending portion extending outwardly from an outer edge of each of the first end face and the second end face. Each of the terminals is connected to the extending portion and disposed to face a side surface of the honeycomb structure.

### CROSS REFERENCE TO RELATED APPLICATIONS

The present invention claims the benefit of priorities to Japanese Patent Application No 2021-104974 filed on Jun. 24, 2021 and PCT Patent Application No. PCT/JP2022/013315 filed on Mar. 22, 2022, the entire contents of which are incorporated herein by reference in its entirety.

### FIELD OF THE INVENTION

The present invention relates to a heater element, a heater unit, and a heater system for heating a vehicle interior.

### BACKGROUND OF THE INVENTION

In recent years, a heater system has been used as a heater system for heating a vehicle interior of an electric vehicle. The heater system uses a vapor compression heat pump as a main heater, while supplementarily using a heater utilizing Joule heat when rapid heating is required at the start of the vehicle or when the outside temperature is extremely low.

As the heater utilizing Joule heat used in the heater system, Patent Literature 1 proposes a heater unit in which heater elements having PTC elements integrated with aluminum fins are arranged in a stacked manner.

However, the heater element includes many parts such as insulating plates and conductive plates in addition to the PTC elements and the aluminum fins. Therefore, the heater element has problems that it has a complicated structure and is expensive due to high assembly costs.

Therefore, Patent Literature 2 proposes a heater element using a honeycomb structure that is compact and capable of increasing a heat transfer area per unit volume. The heater element using the honeycomb structure has an advantage of having a simpler structure than that of the heater element as described above.

The heater element described in Patent Literature 2 includes a honeycomb structure having an outer peripheral wall and partition walls disposed on an inner side of the outer peripheral wall, the partition walls defining a plurality of cells, each of the cells forming a flow path from a first end face to a second end face, wherein a pair of electrodes are formed on both end faces of the honeycomb structure by applying and baking an electrode material. The pair of electrodes can be electrically connected to a conductive wire connected to an external power supply, including indirectly connecting the electrodes to the conductive wire via a ring-shaped conductive member in contact with the pair of electrodes, or directly connecting the conductive wire to the pair of electrodes. The purpose of using the ring-shaped conductive member is to increase a contact area between the conductive wire and the pair of electrodes, thereby lowering the electrical resistance. On the other hand, the method of directly connecting the conductive wire to the pair of electrodes has a smaller conductive area, which is unreliable in maintaining sufficient electrical conductivity. Further, the ring-shaped conductive member is connected to the outer peripheral wall of the honeycomb structure so as to block the cells adjacent to the outer peripheral wall. Therefore, a heater element including this ring conductive member has fewer air flow paths, resulting in increased pressure loss. As a result, the flow rate of the air passing through the cells of the honeycomb structure increases, resulting in insufficient heat transfer from the partition walls to the air so that the heating performance is deteriorated.

The present invention has been made to solve the above problems. An object of the present invention is to provide a heater element, a heater unit, and a heater system for heating a vehicle interior, which suppress an increase in pressure loss and have high heating performance.

### PRIOR ART

### Patent Literatures

[Patent Literature 1] Japanese Patent Application Publication No. 2007-157528 A
[Patent Literature 2] WO 2020/036067 A1

### SUMMARY OF THE INVENTION

The above problems are solved by the present invention as described below, and the present invention is as follows:

The present invention relates to a heater element, comprising:
a honeycomb structure comprising an outer peripheral wall and partition walls disposed on an inner side of the outer peripheral wall, the partition walls defining a plurality of cells, each of the cells extending from a first end face to a second end face to form a flow path, the outer peripheral wall and the partition walls being made of a material having a PTC property;
a pair of electrode layers provided on the outer peripheral wall and the partition walls on the first end face and the second end face; and
terminals capable of electrically connecting the electrode layers to a conducting wire,
wherein at least a part of each of the electrode layers has an extending portion extending outwardly from an outer edge of each of the first end face and the second end face, and
wherein each of the terminals is connected to the extending portion and disposed to face a side surface of the honeycomb structure.

The present invention also relates to a heater element, comprising:
a honeycomb structure comprising an outer peripheral wall, partition walls disposed on an inner side of the outer peripheral wall, the partition walls defining a plurality of cells, each of the cells extending from a first end face to a second end face to form a flow path, and plugged portions where the cells of at least part of outer edge regions of the first end face and the second end face are plugged, the outer peripheral wall and the partition walls being made of a material having a PTC property;
a pair of electrode layers provided on the outer peripheral wall, the partition walls and the plugged portions on the first end face and the second end face; and
terminals capable of electrically connecting the electrode layers to a conducting wire,
wherein the terminals are provided at positions facing the plugged portions in a flow path direction of the honeycomb structure.

Further, the present invention relates to a heater unit comprising the two or more heater elements.

The present invention also relates to a heater system for heating a vehicle interior, comprising:
the heater element or the heater unit comprising the two or more heater elements;
an inflow pipe for communicating an outside air introduction portion or a vehicle interior with an inflow port of the heater element or the heater unit;
a battery for applying a voltage to the heater element or the heater unit; and
an outflow pipe for communicating an outflow port of the heater element or the heater unit with the vehicle interior.

### BRIEF DESCRIPTION OF THE DRAWINGS

FIG. 1 is a schematic view of an end face of a heater element according to an embodiment of the invention;

FIG. 2 is a schematic view of a cross section of the heater element in FIG. 1, which is parallel to a flow path direction of a honeycomb structure;

FIG. 3 is a schematic view of a cross section of another heater element according to Embodiment 1 of the present invention, which is parallel to a flow path direction of a honeycomb structure;

FIG. 4 is a schematic view showing an arrangement example of a heater system according to Embodiment 1 of the present invention;

FIG. 5 is a schematic view of an end face of a heater element according to Embodiment 2 of the present invention;

FIG. 6 is a schematic view of a cross section of the heating element in FIG. 5, which is parallel to a flow path direction of a honeycomb structure; and

FIG. 7 is a schematic view of a cross section of another heating element according to Embodiment 2 of the present invention, which is parallel to a flow path direction of a honeycomb structure.

### DETAILED DESCRIPTION OF THE INVENTION

Hereinafter, embodiments of the present invention will be specifically described with reference to the drawings. It is to understand that the present invention is not limited to the following embodiments, and those which have appropriately added changes, improvements and the like to the following embodiments based on knowledge of a person skilled in the art without departing from the spirit of the present invention fall within the scope of the present invention.

### Embodiment 1

### (1. Heater Element)

A heater element according to Embodiment 1 of the present invention can be suitably utilized as a heater element for heating a vehicle interior of a vehicle. The vehicle includes, but not limited to, automobiles and electric railcars. Non-limiting examples of the automobile include a gasoline vehicle, a diesel vehicle, a gas fuel vehicle using CNG (a compressed natural gas) or LNG (a liquefied natural gas), a fuel cell vehicle, an electric vehicle, and a plug-in hybrid vehicle. The heater element according to Embodiment 1 of the present invention can be particularly suitably used for a vehicle having no internal combustion engine such as electric vehicles and electric railcars.

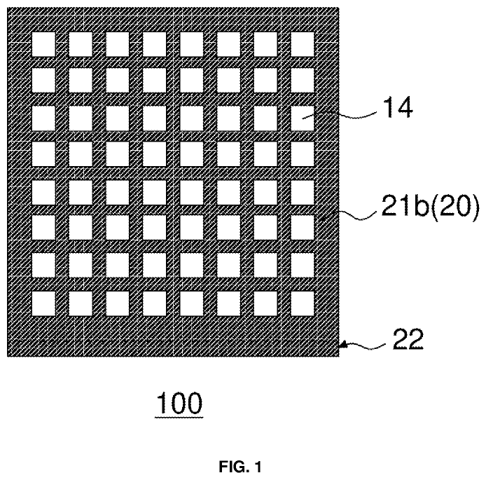

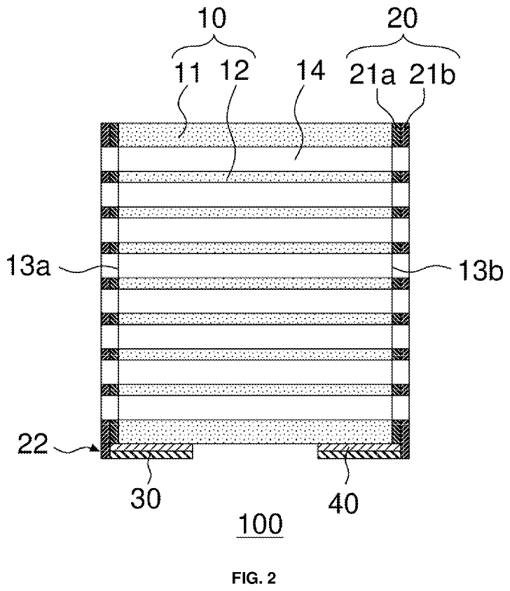

FIG. 1 is a schematic view of an end face of a heater element according to Embodiment 1 of the present invention. FIG. 2 is a schematic view of a cross section of the heater element in FIG. 1, which is parallel to a flow path direction of a honeycomb structure.

As shown in FIGS. 1 and 2, a heater element 100 includes: a honeycomb structure 10 having an outer peripheral wall 11 and partition walls 12 disposed on an inner side of the outer peripheral wall 11, the partition walls 12 defining a plurality of cells 14 each extending from a first end face 13a to a second end face 13b to form a flow path; a pair of electrode layers 20 provided on the outer peripheral wall 11 and the partition walls 12 on the first end face 13a and the second end face 13b; and terminals 30 capable of electrically connecting the electrode layers 20 to a conducting wire. The outer peripheral wall 11 and the partition walls 12 are made of a material having a PTC (Positive Temperature Coefficient) property. At least a part of each of the electrode layers 20 has an extending portion 22 extending outwardly from an outer edge of each of the first end face 13a and the second end face 13b. Each of the terminals 30 is connected to the extending portion 22 and disposed to face a side surface of the honeycomb structure 10. By thus connecting and arranging the terminals 30, a contact area between the electrode layers 20 and the terminals 30 can be increased without blocking the cells 14, so that an amount of power supplied from the outside can be easily increased, and the heating performance can be improved.

Each member forming the heater element 100 will be described below in detail.

### (1-1. Honeycomb Structure 10)

The shape of the honeycomb structure 10 is not particularly limited as long as it has the outer peripheral wall 11 and the partition walls 12 that are disposed on the inner side of the outer peripheral wall 11 and define the plurality of cells 14 each extending from the first end face 13a to the second end face 13b to form the flow path. As the shape of the honeycomb structure 10, for example, a cross section (outer shape) orthogonal to the flow path direction (the extending direction of the cells 14) can be polygonal (quadrangular (rectangular, square), pentagonal, hexagonal, heptagonal, octagonal, etc.), circular, oval (egg-shaped, elliptical, elliptic, rounded rectangular, etc.), and the like. The end faces (first end face 13a and second end face 13b) have the same shape as the cross section. Also, when the cross section and the end faces are polygonal, the corners may be chamfered.

The shape of each cell 14 is not particularly limited, but it may be polygonal (quadrangular, pentagonal, hexagonal, heptagonal, octagonal, etc.), circular, or oval in the cross section orthogonal to the flow path direction. These shapes may be alone or in combination of two or more. Moreover, among these shapes, the quadrangle or the hexagon is preferable. By providing the cells 14 having such a shape, it is possible to reduce the pressure loss when the air flows. FIGS. 1 and 2 show, as an example, a honeycomb structure 10 in which the cross section (outer diameter) and the shape of each cell 14 are quadrangular in the cross section orthogonal to the flow path direction.

The honeycomb structure 10 may be a honeycomb joined body having a plurality of honeycomb segments and joining layers that join the plurality of honeycomb segments together. The use of the honeycomb joined body can increase the total cross-sectional area of the cells 14, which is important for ensuring the flow rate of air, while suppressing cracking.

It should be noted that the joining layer can be formed by using a joining material. The joining material is not particularly limited, but a ceramic material obtained by adding a solvent such as water to form a paste can be used. The joining material may contain ceramics having a PTC property, or may contain the same ceramics as the outer peripheral wall 11 and the partition wall 12. In addition to the role of joining the honeycomb segments to each other, the joining material can also be used as an outer peripheral coating material after joining the honeycomb segments.

The outer peripheral wall 11 and the partition walls 12 forming the honeycomb structure 10 are made of a material having a PTC property.

The material having the PTC property is a material that can generate heat by electrical conduction. Therefore, an air can be heated by heat transfer from the heat-generating outer peripheral wall 11 and partition walls 12 until the air in the vehicle interior flows in from the first end face 13a, passes through the plurality of cells 14, and flows out from the second end face 13b. Further, the material having the PTC property has characteristics such that when the temperature increases and exceeds the Curie point, the resistance value is sharply increased, resulting in a difficult for electricity to flow. Therefore, when the temperature of the heater element 100 becomes high, the partition wall 12 (or the outer peripheral wall 11 if necessary) limits the current flowing through them, thereby suppressing excessive heat generation of the heater element 100.

The material having the PTC property is not particularly limited, but materials containing barium titanate (BaTiO₃) as a main component are preferable, and materials containing barium titanate (BaTiO₃)-based crystals as a main component in which part of Ba is substituted with a rare earth element are more preferable. As used herein, the term “main component” means a component in which a proportion of the component is more than 50% by mass of the total component. The content of BaTiO₃-based crystalline particles can be determined by, for example, fluorescent X-ray analysis, EDAX (energy dispersive X-ray) analysis, or the like. Other crystalline particles can also be measured by the same method. Further, the thermal expansion coefficient of the material containing barium titanate (BaTiO₃) as a main component is 8 to 15 ppm/K. Here, the thermal expansion coefficient means the thermal expansion coefficient measured according to JIS R1618: 2002, “Measuring method of thermal expansion of fine ceramics by thermomechanical analysis”.

The compositional formula of BaTiO₃-based crystalline particles, in which part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of Sc, Y, La, Ce, Pr, Nd, Eu, Gd, Dy, Ho, Er and Yb, and more preferably La. The x value is preferably 0.001 or more, and more preferably 0.0015 or more, and even more preferably 0.002 or more, in terms of suppressing excessively high electrical resistance at room temperature. On the other hand, x is preferably 0.001 or less, and more preferably 0.009 or less, and even more preferably 0.002 or less, in terms of preventing the electrical resistance at room temperature from becoming too high due to insufficient sintering.

The BaTiO₃-based crystalline particles in which part of Ba is substituted with the rare earth element preferably have a (Ba+rare earth element)/Ti ratio of from 1.005 to 1.050. By controlling the (Ba+rare earth element)/Ti ratio to such a range, the electrical resistance at room temperature can be stably reduced. The element ratio of Ba, the rare earth element, and Ti can be determined by, for example, X-ray fluorescence analysis and ICP-MS (inductively coupled plasma mass spectrometry).

The BaTiO₃-based crystalline particles in which part of Ba is substituted with the rare earth element preferably have an average crystal grain size of from 5 to 200 μm, and more preferably from 5 to 180 μm, and even more preferably from 5 to 160 μm. By controlling the average crystal grain size to such a range, the electrical resistance at room temperature can be stably reduced.

The average crystal grain size of the BaTiO₃-based crystalline particles can be measured as follows. A square sample having 5 mm×5 mm×5 mm is cut out from the ceramics and encapsulated with a resin. The encapsulated sample is mirror-polished by mechanical polishing and observed by SEM. The SEM observation is carried out using, for example, a model S-3400N from Hitachi High-Tech Corporation, at an acceleration voltage of 15 kV and at magnifications of 3000. In the SEM observation image (30 μm in length×45 μm in width), four straight lines each having a thickness of 0.3 μm were drawn at intervals of 10 μm across the entire vertical direction of the field of view, and the number of BaTiO₃-based crystalline particles through which these lines pass even at a part of them is counted. An average of the SEM images at four or more positions where the length of the straight line is divided by the number of BaTiO₃-based crystalline particles is defined as the average crystal grain size.

The content of the BaTiO₃-based crystalline particles in which a part of Ba is substituted with the rare earth element in the ceramics is not particularly limited as long as it is determined to be the main component, but it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

The content of the BaTiO₃-based crystalline particles can be measured by, for example, fluorescent X-ray analysis or EDAX (energy dispersive X-ray) analysis. Other crystalline particles can be measured in the same manner as this method.

The ceramics used for the outer peripheral wall 11 and the partition walls 12 preferably contains Ba₆Ti₁₇O₄₀ crystalline particles. The presence of Ba₆Ti₁₇O₄₀ crystalline particles in the ceramics can reduce the electrical resistance at room temperature. Although not wishing to be bound by any theory, it is believed that Ba₆Ti₁₇O₄₀ crystalline particles are liquefied during a firing process to promote rearrangement, grain growth and densification of BaTlO₃-based crystalline particles, thus reducing the electrical resistance at room temperature.

The content of the Ba₆Ti₁₇O₄₀ crystalline particles in the ceramics may be from 1.0 to 10.0% by mass, and preferably from 1.2 to 8.0% by mass, and even more preferably from 1.5 to 6.0% by mass. The content of the Ba₆Ti₁₇O₄₀ crystalline particles of 1.0% by mass or more can provide an effect of the presence of the Ba₆Ti₁₇O₄₀ crystalline particles (i.e., an effect of reducing the electric resistance at room temperature). Further, the content of the Ba₆Ti₁₇O₄₀ crystalline particles of 10.0% by mass or less can ensure the PTC property.

The ceramics used for the outer peripheral wall 11 and the partition walls 12 can further contain BaCO₃ crystalline particles. The BaCO₃ crystalline particles are those derived from BaCO₃ powder, which is a raw material for the ceramics.

The BaCO₃ crystalline particles may not be contained in the ceramics because they have substantially no effect on the electrical resistance of the ceramics at room temperature. However, if the content of BaCO₃ crystalline particles in the ceramics is too high, it may affect the electrical resistance at room temperature, and the number of other crystalline particles may decrease, so that desired properties may not be obtained. Therefore, the content of the BaCO₃ crystalline particles is preferably 2.0% by mass or less, and more preferably 1.8% by mass or less, and further preferably 1.5% by mass or less. The lower limit of the content of BaCO₃ crystalline particles is not particularly limited, but it may generally be 0.1% by mass, and preferably 0.2% by mass.

The ceramics used for the outer peripheral wall 11 and the partition walls 12 may further contain a component(s) conventionally added to materials having the PTC property, in addition to the above crystalline particles. Such a component includes additives such as shifters, property improving agents, metal oxides and conductor powder, as well as unavoidable impurities.

In terms of reduction of the environmental load, it is desirable that the ceramics used for the outer peripheral wall 11 and the partition walls 12 is substantially free of lead (Pb). More particularly, the ceramics preferably has a Pb content of 0.01% by mass or less, and more preferably 0.001% by mass or less, and still more preferably 0% by mass. The lower Pb content can allow heated air to be safely applied to organisms such as humans by contacting the ceramics, for example. In the ceramics, the Pb content is preferably less than 0.03% by mass, and more preferably less than 0.01% by mass, and further preferably 0% by mass, as converted to PbO. The lead content can be determined by, for example, fluorescent X-ray analysis, ICP-MS (inductively coupled plasma mass spectrometry), or the like.

It is preferable that the ceramics used for the outer peripheral wall 11 and the partition walls 12 is substantially free of an alkali metal which may affect the electric resistance at room temperature. More particularly, the ceramics preferably has an alkali metal content of 0.01% by mass or less, and more preferably 0.001% by mass or less, and still more preferably 0% by mass. By controlling the content of the alkali metal to such a range, the electrical resistance at room temperature can be stably reduced. The alkali metal content can be determined by, for example, fluorescent X-ray analysis, ICP-MS (inductively coupled plasma mass spectrometry), or the like.

The material making up the outer peripheral wall 11 and the partition walls 12 preferably have a Curie point of 100° C. or more, and more preferably 110° C. or more, and even more preferably 125° C. or more, in terms of efficiently heating the air. Further, the upper limit of the Curie point is preferably 250° C., and preferably 225° C., and even more preferably 200° C., and still more preferably 150° C., in terms of safety as a component placed in the vehicle interior or near the vehicle interior.

The Curie point of the material making up the outer peripheral wall 11 and the partition walls 12 can be adjusted by the type of shifter and an amount of the shifter added. For example, the Curie point of barium titanate (BaTlO₃) is about 120° C., but the Curie point can be shifted to the lower temperature side by substituting part of Ba and Ti with one or more of Sr, Sn and Zr.

In the present invention, the Curie point is measured by the following method. A sample is attached to a sample holder for measurement, mounted in a measuring tank (e.g., MINI-SUBZERO MC-810P, from ESPEC), and a change in electrical resistance of the sample as a function of a temperature change when the temperature is increased from 10° C. is measured using a DC resistance meter (e.g., Multimeter 3478A, from YHP). Based on an electrical resistance-temperature plot obtained by the measurement, a temperature at which the resistance value is twice the resistance value at room temperature (20° C.) is defined as the Curie point.

In an embodiment, the honeycomb structure 10 has a thickness of the partition wall 12 of 0.125 mm or less, a cell density of 93 cells/cm² or less, and a cell pitch of 1.0 mm or more. By controlling the thickness of the partition wall 12, an increase in pressure loss when the air passes through the cells 14 can be suppressed, so that the output of a blower or the like can be suppressed. From the viewpoint of stably obtaining such effects, it is preferable that the thickness of the partition wall 12 is 0.075 mm or less, the cell density is 62 cells/cm² or less, and the cell pitch is 1.3 mm or more.

Although the lower limit of the thickness of the partition wall 12 is not particularly limited, it may preferably be 0.02 mm, and more preferably 0.05 mm. Although the lower limit of the cell density is not particularly limited, it may preferably be 10 cells/cm², and more preferably 20 cells/cm². Although the upper limit of the cell pitch is also not particularly limited, but it may preferably be 3.0 mm, and more preferably 2.0 mm.

As used herein, the thickness of the partition wall 12 refers to a length of a line segment that crosses the partition wall 12 when the centers of gravity of adjacent cells 14 are connected by the line segment in a cross section orthogonal to the flow path direction. The thickness of the partition wall 12 refers to an average value of the thicknesses of all the partition walls 12. Also, the cell density of the honeycomb structure 10 is a value obtained by dividing the number of cells by the area of each end face of the honeycomb structure 10. Further, the cell pitch of the honeycomb structure 10 refers to a length of a line segment connecting the centers of gravity of two adjacent cells 14 on each end face of the honeycomb structure 10.

In another aspect, the honeycomb structure 10 has a thickness of the partition wall 12 of 0.14 to 0.36 mm, a cell density of 2.54 to 46.5 cells/cm², and an opening ratio of the cells 14 of 80% or more. By controlling the thickness of the partition wall 12, the cell density, and the opening ratio of the cells 14 within such ranges, the strength of the honeycomb structure 10 and the contact area with the air can be increased while suppressing an increase in pressure loss. From the viewpoint of stably obtaining such effects, the thickness of the partition wall 12 is preferably 0.15 to 0.35 mm, the cell density is preferably 2.80 to 45.0 cells/cm², and the opening ratio of the cells 14 is preferably 83% or more.

It should be noted that the upper limit value of the opening ratio of the cells 14 is not particularly limited, but it may preferably be 94%, and more preferably 92%.

As used herein, the opening ratio of the cells 14 of the honeycomb structure 10 is a value obtained by dividing areas of the cells 14 in the cross section orthogonal to the flow path direction of the honeycomb structure 10 by the area of the entire cross section (the total area of the outer peripheral wall 11, the partition walls 12 and the cells 14), expressed by a percentage.

The honeycomb structure 10 has a volume resistivity at 25° C. of 0.5 to 1000 Ω·cm at room temperature. The volume resistivity in such a range can be determined to be lower electrical resistance at room temperature (25° C.). The lower electric resistance at room temperature can ensure heat generation performance required for heating, and can suppress an increase in power consumption.

The volume resistivity of the honeycomb structure 10 can be determined by the following measurement. Two or more samples each having a dimension of 30 mm×30 mm×15 mm are randomly cut and collected from the honeycomb structure 10. The electrical resistance at the measurement temperature is then measured by the two-terminal method, and the volume resistivity is calculated from shapes of the samples. An average value of the volume resistivities of all the samples is defined as a measured value at a measured temperature.

The length of the honeycomb structure 10 in the flow path direction and the cross-sectional area orthogonal to the flow path direction may be adjusted according to the required size of the heater element 100, and are not particularly limited. For example, when used in a compact heater element 100 while ensuring a predetermined function, the honeycomb structure 10 can have a length of 2 to 20 mm in the flow path direction and a cross-sectional area of 10 cm² or more orthogonal to the flow path direction. Although the upper limit of the cross-sectional area orthogonal to the flow path direction is not particularly limited, it is, for example, 300 cm².

### (1-2. Electrode Layer 20)

The pair of electrode layers 20 are provided on the outer peripheral wall 11 and the partition walls 12 on the first end face 13a and the second end face 13b. By applying a voltage in the flow path direction of the honeycomb structure 10 by the pair of electrode layers 20 thus provided, the heat can be generated in the honeycomb structure 10 by Joule heat.

Further, at least a part of each of the electrode layers 20 may have an extending portion extending outwardly from an outer edge of each of the first end face 13a and the second end face 13b. By providing the extending portion 22, the contact area between the electrode layers 20 and the terminals 30 can be increased, so that an amount of power supplied from the outside can be easily increased, and the heating performance of the heater element 100 can be improved.

Each electrode layer 20 may have a single-layer structure or a structure of two or more layers, but it may preferably be a two-layer structure in order to improve the joinability to the first end face 13a and the second end face 13b of the honeycomb structure 10, and to maintain good electrical conductivity from the terminals 30 to the outer peripheral wall 11 and the partition walls 12. For example, it may be a two-layer structure including a first electrode layer 21a having good joinability to the first end face 13a and the second end face 13b of the honeycomb structure 10, and a second electrode layer 21b having good joinability to the first electrode layer 21a and the terminal 30. In the case of the electrode layers 20 having the two-layer structure, the extending portion(s) 22 can be provided on the first electrode layer 21a, the second electrode layer 21b, or both of them, but from the viewpoint of manufacturability, the extending portion 22 can preferably be provided on the second electrode layer 21b.

Each of the electrode layers 20 may employ, for example, a metal or alloy containing at least one selected from Cu, Ag, Al, Ni and Si, although not particularly limited thereto. It is also possible to use an ohmic electrode layer capable of ohmic contact with the outer peripheral wall 11 and/or the partition walls 12 which have the PTC property. The ohmic electrode layer may employ an ohmic electrode layer containing, for example, at least one selected from Au, Ag and In as a base metal, and containing at least one selected from Ni, Si, Ge, Sn, Se and Te for n-type semiconductors as a dopant. In particular, the ohmic electrode layer is suitable for use as the first electrode layer 21a.

An example of the structure of the electrode layer 20 is a two-layer structure having an Al—Zn layer as the first electrode layer 21a and an Al layer as the second electrode layer 21b.

The thickness of each electrode layer 20 is not particularly limited, and it may be appropriately set according to the method for forming the electrode layer 20. The method for forming the electrode layers 20 includes metal deposition methods such as sputtering, vapor deposition, electrolytic deposition, and chemical deposition. Alternatively, the electrode layer 20 can be formed by applying an electrode paste and then baking it, or by thermal spraying. Furthermore, the electrode layer 20 may be formed by joining metal or alloy plates.

It is preferable that the thickness of each electrode layer 20 is about 5 to 30 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal or alloy plates, the thickness of the electrode layer 20 is preferably about 5 to 100 μm.

### (1-3. Terminal 30)

The terminals 30 are members for electrically connecting the electrode layers 20 to a conducting wire.

Each terminal 30 is connected to the extending portion 22 and is arranged to face the side surface of the honeycomb structure 10. By thus connecting and arranging the terminals 30, the contact area between the electrode layers 20 and the terminals 30 can be increased, so that the amount of power supplied from the outside can be easily increased, and the heating performance of the heater element 100 can be improved. Further, since it is possible to avoid clogging of the cells 14 near the outer peripheral wall 11 and ensure an air flow path, so that an increase in pressure loss can be suppressed. Since the terminals 30 are arranged along the side surface of the honeycomb structure 10, the heating element 100 can also be made more compact.

The terminal 30 may be made of, for example, a metal, although not limited thereto. The metal that can be used herein includes a single metal, an alloy, and the like. In terms of corrosion resistance, electrical resistance, and linear expansion rate, for example, the metal may preferably be an alloy containing at least one selected from the group consisting of Cr, Fe, Co, Ni, Cu, and Ti, and more preferably stainless steel, Fe—Ni alloys, and phosphorus bronze.

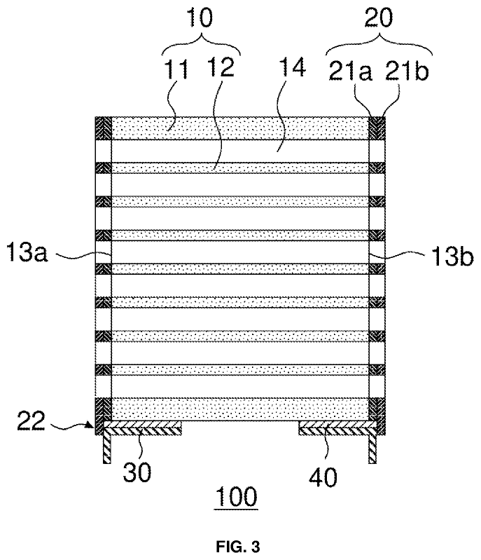

The shape and size of each terminal 30 are not particularly limited, and they may be adjusted as appropriate depending on the structure of the extending portion 22 of the electrode layer 20 and the like. For example, each terminal 30 can have an L-shaped cross section parallel to the flow path direction as shown in FIG. 3. Such a shape increases the degree of structural freedom when connecting the terminals 30 to the conducting wire.

A method of connecting each terminal 30 to each electrode layer 20 is not particularly limited as long as they are electrically connected to each other. They may be connected by, for example, diffusion joining, a mechanical pressurizing mechanism, welding, or the like.

### (1-4. Insulating Portion 40)

The heater element 100 according to Embodiment 1 of the present invention may optionally be provided with an insulating portion 40 between the side surface of the honeycomb structure 10 and the terminal 30. By providing the insulating portion 40, it is possible to suppress uneven heating of the honeycomb structure 10 due to electric conduction from the side surface of the honeycomb structure 10. Further, the insulating portion 40 also has a function of supporting the terminal 30 on the side surface of the honeycomb structure 10.

The insulating portion 40 is not particularly limited, but, for example, a film (for example, a coating film formed by printing) formed from an insulating material such as alumina, ceramics, or heat-resistant resin can be used.

The thickness of the insulating portion 40 is not particularly limited, but it is preferably 10 μm or more, and more preferably 50 μm or more. The thickness in this range allows the terminal 30 to be stably supported on the side surface of the honeycomb structure 10 while ensuring insulation between the side surface of the honeycomb structure 10 and the terminal 30.

### (1-5. Method for Producing Heater Element 100)

Next, a method for producing a heater element 100 according to Embodiment 1 of the invention will be exemplified.

When the material of the honeycomb structure 10 making up the heater element 100 is ceramics, a method for producing the honeycomb structure 10 includes a forming step and a firing step.

In the forming step, a green body containing a ceramic raw material including BaCO₃ powder, TiO₂ powder, and rare earth nitrate or hydroxide powder is formed to prepare a honeycomb formed body.

The ceramic raw material can be obtained by dry-mixing the powders so as to have a desired composition.

The green body can be obtained by adding a dispersion medium, a binder, a plasticizer and a dispersant to the ceramic raw material and kneading them. The green body may optionally contain additives such as shifters, metal oxides, property improving agents, and conductor powder.

The blending amount of the components other than the ceramic raw material is not particularly limited as long as the relative density of the honeycomb formed body is 60%.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total volume of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extrude the green body. In the extrusion, a die having a desired overall shape, cell shape, partition wall thickness, cell density and the like can be used.

The relative density of the honeycomb formed body obtained by extrusion is 60% or more, and preferably 61% or more. By controlling the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include conventionally known drying methods such as hot air drying, microwave drying, dielectric drying, drying under reduced pressure, drying in vacuum, and freeze drying. Among these, a drying method that combines the hot air drying with the microwave drying or dielectric drying is preferable in that the entire formed body can be rapidly and uniformly dried.

The firing step includes maintaining the ceramic formed body at a temperature of from 1150 to 1250° C., and then increasing the temperature to a maximum temperature of from 1360 to 1430° C. at a heating rate of 20 to 500° C./hour, and maintaining the temperature for 0.5 to 5 hours.

The maintaining of the honeycomb formed body at the maximum temperature of from 1360 to 1430° C. for 0.5 to 5 hours can provide the honeycomb structure 10 mainly based on BaTiO₃-based crystal particles in which a part of Ba is substituted with the rare earth element.

Further, the maintaining at the temperature of from 1150 to 1250° C. can allow the Ba₂TiO₄ crystal particles generated in the firing step to be easily removed, so that the honeycomb structure 10 can be densified.

Further, the heating rate of 20 to 500° C./hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure 10.

The retention time at 1150 to 1250° C. is not particularly limited, but it may preferably be from 0.5 to 5 hours. Such a retention time can lead stable and easy removal of Ba₂TiO₄ crystal particles generated in the firing step.

The firing step preferably includes maintaining at 900 to 950° C. for 0.5 to 5 hours. The maintaining at 900 to 950° C. for 0.5 to 5 hours can lead to sufficient decomposition of BaCO₃, so that the honeycomb structure 10 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of controlling electrical characteristics and production cost.

A firing furnace used in the firing step and the degreasing step is not particularly limited, but it may be an electric furnace, a gas furnace, or the like.

The electrode layers 20 are formed on the outer peripheral wall 11 and the partition walls 12 on the first end face 13a and the second end face 13b of the honeycomb structure 10 thus obtained. The electrode layers 20 can be formed by the method as described above.

Subsequently, when providing the insulating part 40 between the side surface of the honeycomb structure 10 and the terminal 30, the insulating portion 40 is formed by applying an insulating material to the side surface of the honeycomb structure 10.

The terminals 30 are then placed at predetermined positions and connected to the electrode layers 20. As a method for connecting the electrode layers 20 to the terminals 30, the above method can be used. It should be noted that each terminal 30 may extend outwardly from the side surface of the honeycomb structure 10. In this case, each terminal 30 may be composed of a plurality of metal parts and joined together. Further, the connection between the plurality of metal parts may be brazing, welding, or other mechanical connections such as a spring contact type.

### (1-6. Method for Using Heater Element 100)

The heater element 100 according to Embodiment 1 of the present invention allows the honeycomb structure 10 to generate heat by applying a voltage via the pair of electrode layers 20 from the terminals 30, for example. By selecting the volume resistance of the material used for the honeycomb structure 10 and the size of the honeycomb structure 10, the voltage used (applied) can be adjusted from 12V to 800V, as needed.

When the heater element 100 generates heat due to the application of the voltage, the air can be heated by allowing the air to flow through the cells 14. A temperature of the air flowing into the cells 14 can be, for example, −60° C. to 20° C., and typically −10° C. to 20° C.

In the heater element 100 according to Embodiment 1 of the present invention, the terminals 30 are connected to and placed at the extending portions of the electrode layers 20 provided on the first end face 13a and the second end face 13b of the honeycomb structure 10 as described above, the contact area between the electrode layers 20 and the terminals 30 can be increased without blocking the cells 14. Therefore, the amount of power supplied from the outside can easily be increased, thereby improving heating performance. Further, since it is possible to avoid clogging of the cells 14 near the outer peripheral wall 11 and ensure the air flow path, an increase in pressure loss can be suppressed. Also, the heater element 100 according to Embodiment 1 of the present invention has a simpler structure than that of an existing heater element in which a PTC element and an aluminum fin are integrated via an insulating ceramic plate, and can prevent the heater unit from becoming larger. Further, in the existing heater element, the PTC element is not in direct contact with the gas, resulting in an insufficient heating rate (heating time) of the air, whereas in the heater element 100 according to Embodiment 1 of the present invention, the honeycomb structure 10 in which the outer peripheral wall 11 and the partition walls 12 are made of a material having the PTC property is in direct contact with the air, resulting in an increased heating rate of the air.

### (2. Heater Unit)

The heater unit according to Embodiment 1 of the present invention can be suitably used as a heater unit for heating a vehicle interior of a vehicle. The heater unit according to Embodiment 1 of the present invention includes the two or more heater elements 100. In particular, since the heater unit according to Embodiment 1 of the present invention uses the heater element 100 having higher heat generation performance, the heat generation performance of the heater unit can be improved. Further, since the heater element 100 can be made compact, it is possible to prevent the heater unit from becoming larger.

In the heater unit according to Embodiment 1 of the present invention, the method of arranging the heater elements 100 is not particularly limited. For example, the heater elements 100 may be arranged in a stacked manner so that the side surfaces which are parallel to the flow path direction of the honeycomb structure 10 and are not provided with the electrode layers 20 face each other.

Also, the heater elements 100 arranged in the stacked manner are preferably housed in a housing (housing member). The housing may be made of any material, including, but not limited to, for example, metals and resins. Among them, the material of the housing is preferably the resin. The housing made of the resin can suppress electric shock without grounding.

Between the heater elements 100 arranged in the stacked manner may be insulating materials. Such a configuration can suppress an electrical short circuit between the plurality of heater elements 100. The insulating materials that can be used herein include plate materials, mats, clothes, and the like, which are formed of an insulating material such as alumina or ceramics.

### (3. Heater System)

The heater system according to Embodiment 1 of the present invention can be suitably used as a heater system for heating a vehicle interior of a vehicle. Especially, in the heater system according to Embodiment 1 of the present invention, the heater element 100 or the heater unit including the two or more heater elements 100, which has/have high heat generation performance, is used, so that the heat generation performance of the heater system can be improved. Further, the heater element 100 and the heater unit can be made compact, so that it is possible to prevent the heater system from becoming larger.

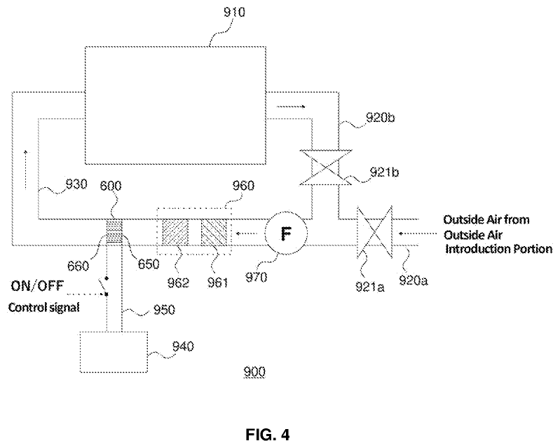

FIG. 4 is a schematic view showing an arrangement example of a heater system according to an embodiment of the present invention.

As shown in FIG. 4, a heater system 900 according to Embodiment 1 of the present invention includes: the heater element 100 or the heater unit 600 according to the embodiment of the present invention; inflow pipes 920a, 920b for communicating an outside air introduction portion or a vehicle interior 910 with an inflow port 650 of the heater element or the heater unit 600; a battery 940 for applying a voltage to the heater element or the heater unit 600; and an outflow pipe 930 for communicating an outflow port 660 of the heater element or the heater unit 600 with the vehicle interior 910.

The heater element or the heater unit 600 can be configured so that the heater element or the heater unit 600 generate heat by electric conduction, for example by being connected to the battery 940 with a conductive wire (an electric wire) 950 and turning on a power switch in the middle of the wire.

Disposed on the upstream side of the heater element or the heater unit 600 can be a vapor compression heat pump 960. In the heater system 900, the vapor compression heat pump 960 is configured as a main heating device, and the heater element or the heater unit 600 is configured as an auxiliary heater. The vapor compression heat pump 960 can be provided with a heat exchanger including: an evaporator 961 that functions to absorb heat from the outside during cooling to evaporate a refrigerant; and a condenser 962 that functions to liquefy a refrigerant gas to release heat to the outside during heating. The vapor compression heat pump 960 is not particularly limited, and a vapor compression heat pump known in the art can be used.

On the upstream side and/or the downstream side of the heater element or the heater unit 600, a blower 970 can be installed. In terms of ensuring safety by arranging high-voltage parts as far as possible from the vehicle interior 910, the blower 970 is preferably installed on the upstream side of the heater element or the heater unit 600. As the blower 970 is driven, the air flows into the heater element or the heater unit 600 from the inside or outside of the vehicle interior 910 through the inflow pipes 920a, 920b. The air is heated while passing through the heater element or heater unit 600 that is generating heat. The heated air flows out from the heater element or the heater unit 600 and is delivered into the vehicle interior 910 through the outflow pipe 930. The outlet of the outflow pipe 930 may be arranged near the feet of an occupant so that the heating effect is particularly high even in the vehicle interior 910, or the pipe outlet may be arranged in a seat to warm the seat from the inside, or may be arranged near a window to have an effect of suppressing fogging of the window.

The inflow pipe 920a and the inflow pipe 920b merge in the middle. The inflow pipe 920a and the inflow pipe 920b can be provided with valves 921a and 921b, respectively, on the upstream side of the confluence. By controlling the opening and closing of the valves 921a, 921b, it is possible to switch between a mode where the outside air is introduced into the heater element or the heater unit 600 and a mode where the air in the vehicle interior 910 is introduced into the heater element or the heater unit 600. For example, the opening of the valve 921a and the closing of the valve 921b results in the mode where the outside air is introduced into the heater element or the heater unit 600. It is also possible to open both the valve 921a and the valve 921b to introduce the outside air and the air in the vehicle interior 910 into the heater element or the heater unit 600 at the same time.

### Embodiment 2

### (1. Heater Element)

A heater element according to Embodiment 2 of the present invention can be suitably utilized as a heater element for heating a vehicle interior of a vehicle, as with the heater element 100 according to Embodiment 1 of the present invention.

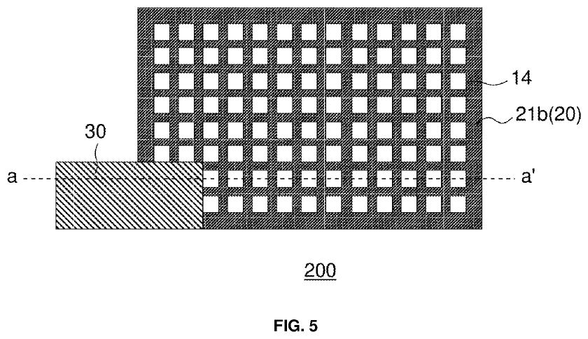

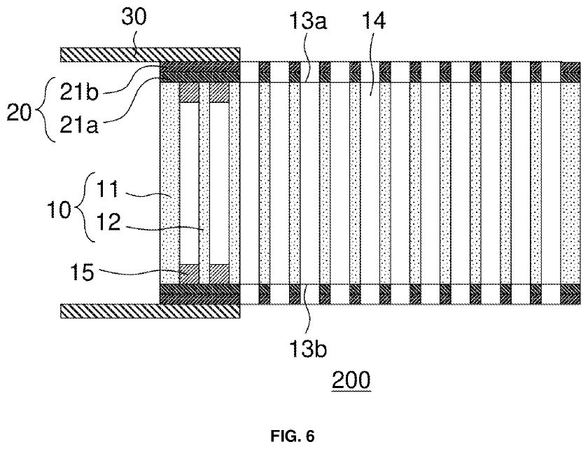

FIG. 5 is a schematic view of an end face of a heater element according to Embodiment 2 of the present invention. FIG. 6 is a schematic view of a cross section (cross section taken along the line a-a′) of the heater element in FIG. 5, which is parallel to a flow path direction of a honeycomb structure.

As shown in FIGS. 5 and 6, a heater element 200 according to Embodiment 2 of the present invention includes: a honeycomb structure 10 having an outer peripheral wall 11 and partition walls 12 disposed on an inner side of the outer peripheral wall 11, the partition walls 12 defining a plurality of cells 14 each extending from a first end face 13a to a second end face 13b to form a flow path, and plugged portions 15 where at least some cells 14 in outer edge regions of the first end face 13a and the second end face 13b are plugged; a pair of electrode layers 20 provided on the outer peripheral wall 11, the partition walls 12 and the plugged portions 15 on the first end face 13a and the second end face 13b; and terminals 30 capable of electrically connecting the electrode layers 20 to a conducting wire. The outer peripheral wall 11 and the partition walls 12 are made of a material having a PTC property. The terminals 30 are provided at positions facing the plugged portions 15 in a flow path direction of the honeycomb structure 10. By thus connecting and arranging the terminals 30, only a portion of the cells 14 adjacent to the outer peripheral wall 11 can be closed. Also, a contact area between the electrode layers 20 and the terminals 30 can be increased, so that an amount of power supplied from the outside can be easily increased, and the heating performance can be improved. Furthermore, since only a portion of the cells 14 is blocked, any blockage of the cells 14 near the outer peripheral wall 11 can be reduced, and the air flow path can be ensured, so that an increase in pressure loss can be suppressed.

Hereinafter, members of the heater element 200 will be detailed in detail. It should be noted that each member used in the heater element 200 is basically common to each member used in the heater element 100. Therefore, the common members are given the same reference numerals, descriptions thereof are omitted, and only different members will be described herein.

In addition to the outer peripheral wall 11 and the partition walls 12, the honeycomb structure 10 has the plugged portions 15 where at least some cells 14 in the outer edge regions of the first end face 13a and the second end face 13b are plugged. The providing of the plugged portions 15 can increase the areas of the electrode layers 20 formed on the plugged portions 15 as well as on the peripheral wall 11 and the partition wall 12 around the plugged portions 15. The number of the cells 14 provided with the plugged portions 15 can be, for example, 2 or more and 100 or less, from the viewpoint of connectivity between the terminals 30 and the electrode layers 20 that are arranged facing each other.

As used herein, the “outer edge region of each of the first end face 13a and the second end face 13b” refers to a region from the outer peripheral wall 11 to ¼ of a diameter (or equivalent circle diameter if it is not circular) of each of the first end face 13a and the second end face 13b.

The plugged portions 15 may be made of a material having a thermal expansion coefficient of 8 to 15 ppm/K from the viewpoint of matching the degree of thermal expansion with the material having the PTC property making up the outer peripheral wall 11 and the partition walls 12, although not particularly limited thereto. The thermal expansion coefficient within this range can suppress the generation of cracks due to a difference between the degrees of thermal expansion of the outer peripheral wall 11 and the partition walls 12, and the plugged portions 15, when the heater element 200 is used.

As with the outer peripheral wall 11 and the partition walls 12, the plugged portions 15 are preferably made of a material having a PTC property. By making the plugged portions 15 of the material having the PTC property, the plugged portions 15 as well as the outer peripheral wall 11 and the partition walls 12 can generate heat by electric conduction, so that the heat generation performance of the honeycomb structure 10 is improved.

It should be noted that the material of the plugged portions 15 may be different from the material of the outer peripheral wall 11 and the partition walls 12, but from the viewpoint of productivity, it is preferable that the material be the same.

The plugged portions 15 can be formed by a plugging process known in the art. The plugging process may be performed before or after firing the honeycomb formed body. For example, a thin film with openings at positions corresponding to the cells 14 on the end faces (first end face 13a and second end face 13b) of the honeycomb formed body or honeycomb structure 10 in which the plugged portions 15 are to be formed is attached. Then, the end faces of the honeycomb formed body or honeycomb structure 10 are immersed in a plugging material in the form of slurry, and the plugged material is introduced into the cells 14 of the honeycomb formed body or honeycomb structure 10 that are not blocked with the thin film, whereby the plugged portions 15 filled with the plugging material can be formed. The material used for the plugging material that can be used herein includes a material used for producing a honeycomb formed body.

The electrode layers 20 are provided on the outer peripheral wall 11, the partition walls 12, and the plugged portions 15 on the first end face 13a and the second end face 13b. By providing the electrode layers 20 at such positions, a region having larger areas of the electrode layers 20 can be formed on the plugged portions 15 as well as the peripheral wall 11 and the partition wall 12 around the plugged portions 15.

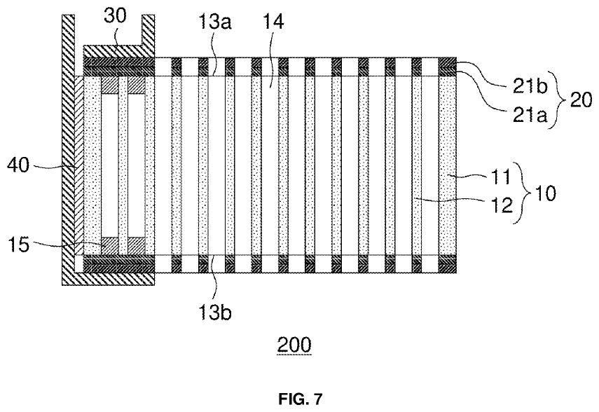

The terminals 30 are provided at positions facing the plugged portions 15 in the flow path direction of the honeycomb structure 10. By thus connecting and arranging the terminals 30, the large areas of the electrode layers 20 and the terminals 30 can be connected to each other. Therefore, the contact area between the electrode layers 20 and the terminals 30 can be increased, so that the amount of power supplied from the outside can be easily increased, and the heating performance can be improved. It should be noted that each terminal 30 may have a shape such as an L-shape in the cross section parallel to the flow path direction as shown in FIG. 7. The terminal 30 having the L-shape or the like may be made by mechanically joining metal members having a plurality of shapes. The metal member making up the terminal 30 may be in the form which is placed on an inner side than the outer edge of the honeycomb structure 10, or may in the form which extends to an outer side than the outer edge of the honeycomb structure 10. In addition to the L-shape, the terminal 30 may also have a U-shape in which the tip of the L-shape is further bent, or may have a curved surface. Such a shape increases the degree of structural freedom when connecting the terminals 30 to the conducting wire. It should be noted that when providing L-shaped terminals 30 each having the structure as shown in FIG. 7, each terminal 30 is preferably configured so that it is not brought into direct contact with the side surface of the outer peripheral wall 11 (the outer peripheral surface parallel to the flow path direction). Specifically, the insulating portion 40 may be disposed between each terminal 30 and the side surface of the outer peripheral wall 11, or a space may be provided between each terminal 30 and the side surface of the outer peripheral wall 11.

Furthermore, the heater element 200 according to Embodiment 2 of the present invention can be used in the same manner as that of the heater element 100.

### (2. Heater Unit)

The heater unit according to Embodiment 2 of the present invention can be suitably used as a heater unit for heating a vehicle interior of a vehicle, as with the heater unit according to Embodiment 1 of the present invention. The heater unit according to Embodiment 2 of the present invention includes the two or more heater elements 200. In particular, since the heater unit according to Embodiment 2 of the present invention uses the heater elements 200 having higher heat generation performance, the heat generation performance of the heater unit can be improved. Further, since the heater element 200 can be made compact, it is possible to prevent the heater unit from becoming larger.

It should be noted that the structure of the heater unit according to Embodiment 2 of the present invention can be the same as that of the heater unit according to Embodiment 1 of the present invention, and therefore descriptions thereof will be omitted.

### (3. Heater System)

The heater system according to Embodiment 2 of the present invention can be suitably used as a heater system for heating a vehicle interior of a vehicle. Especially, in the heater system according to Embodiment 2 of the present invention, the heater element 200 or the heater unit including the two or more heater elements 200, which has/have high heat generation performance, is used, so that the heat generation performance of the heater system can be improved. Further, the heater element 200 and the heater unit can be made compact, so that it is possible to prevent the heater system from becoming larger.

It should be noted that the structure of the heater system according to Embodiment 2 of the present invention can be the same as that of the heater system according to Embodiment 1 of the present invention, and therefore descriptions thereof will be omitted.

### DESCRIPTION OF REFERENCE NUMERALS

10 honeycomb structure
11 outer peripheral wall
12 partition wall
13a first end face
13b second end face
14 cell
15 plugged portion
20 electrode layer
30 terminal
40 insulating layer
100, 200 heater element
600 heater element or heater unit
900 heater system
910 vehicle cabin
920a, 920b inflow pipe
921a, 921b valve
930 outflow pipe
940 battery
950 conductive wire
960 vapor compression heat pump
961 evaporator
962 condenser
970 blower

1. A heater element, comprising:
a honeycomb structure comprising an outer peripheral wall and partition walls disposed on an inner side of the outer peripheral wall, the partition walls defining a plurality of cells, each of the cells extending from a first end face to a second end face to form a flow path, the outer peripheral wall and the partition walls being made of a material having a PTC property;
a pair of electrode layers provided on the outer peripheral wall and the partition walls on the first end face and the second end face; and
terminals capable of electrically connecting the electrode layers to a conducting wire,
wherein at least a part of each of the electrode layers has an extending portion extending outwardly from an outer edge of each of the first end face and the second end face, and
wherein each of the terminals is connected to the extending portion and disposed to face a side surface of the honeycomb structure.

2. The heater element according to claim 1, further comprising an insulating portion provided between a side surface of the honeycomb structure and each of the terminals.

3. A heater element, comprising:
a honeycomb structure comprising an outer peripheral wall, partition walls disposed on an inner side of the outer peripheral wall, the partition walls defining a plurality of cells, each of the cells extending from a first end face to a second end face to form a flow path, and plugged portions where the cells of at least part of outer edge regions of the first end face and the second end face are plugged, the outer peripheral wall and the partition walls being made of a material having a PTC property;
a pair of electrode layers provided on the outer peripheral wall, the partition walls and the plugged portions on the first end face and the second end face; and
terminals capable of electrically connecting the electrode layers to a conducting wire,
wherein the terminals are provided at positions facing the plugged portions in a flow path direction of the honeycomb structure.

4. The heater element according to claim 3, wherein the plugged portions are made of a material having a thermal expansion coefficient of 8 to 15 ppm/K.

5. The heater element according to claim 3, wherein the plugged portions are made of a material having a PTC property.

6. The heater element according to claim 1, wherein each of the electrode layers has a two-layer structure.

7. The heater element according to claim 1, wherein the honeycomb structure has a thickness of the partition wall of 0.125 mm or less, a cell density of 93 cells/cm² or less, and a cell pitch of 1.0 mm or more.

8. The heater element according to claim 1, wherein the honeycomb structure has a thickness of the partition wall of 0.14 to 0.36 mm, a cell density of 2.54 to 46.5 cells/cm², and an opening ratio of the cells of 80% or more.

9. The heater element according to claim 1, wherein the honeycomb structure has a volume resistivity of 0.5 to 200 Ω·cm at 25° C.

10. The heater element according to claim 1, wherein the material having the PTC property is a material containing barium titanate as a main component, the material being substantially free of lead.

11. The heater element according to claim 3, wherein each of the electrode layers has a two-layer structure.

12. The heater element according to claim 3, wherein the honeycomb structure has a thickness of the partition wall of 0.125 mm or less, a cell density of 93 cells/cm² or less, and a cell pitch of 1.0 mm or more.

13. The heater element according to claim 3, wherein the honeycomb structure has a thickness of the partition wall of 0.14 to 0.36 mm, a cell density of 2.54 to 46.5 cells/cm², and an opening ratio of the cells of 80% or more.

14. The heater element according to claim 3, wherein the honeycomb structure has a volume resistivity of 0.5 to 200 Ω·cm at 25° C.

15. The heater element according to claim 3, wherein the material having the PTC property is a material containing barium titanate as a main component, the material being substantially free of lead.

16. A heater unit comprising the two or more heater elements according to claim 1.

17. A heater unit comprising the two or more heater elements according to claim 3.

18. A heater system for heating a vehicle interior, comprising:
the heater element according to claim 1 or the heater unit comprising the two or more heater elements;
an inflow pipe for communicating an outside air introduction portion or a vehicle interior with an inflow port of the heater element or the heater unit;
a battery for applying a voltage to the heater element or the heater unit; and
an outflow pipe for communicating an outflow port of the heater element or the heater unit with the vehicle interior.

19. A heater system for heating a vehicle interior, comprising:
the heater element according to claim 3 or the heater unit comprising the two or more heater elements;
an inflow pipe for communicating an outside air introduction portion or a vehicle interior with an inflow port of the heater element or the heater unit;
a battery for applying a voltage to the heater element or the heater unit; and
an outflow pipe for communicating an outflow port of the heater element or the heater unit with the vehicle interior.
